(19) United States
(12) Patent Application Publication
(10) Pub. No.: US 2021/0144935 A1
(43) Pub. Date: May 20, 2021

(54) Carbon Blocks Made From Photosynthetic Plant Biomass for Long Term Sequestration of the Carbon from Atmospheric Carbon Dioxide (CO2) and a Related Method

(71) Applicant: Brian J. Rampolla, Pittsburgh, PA (US)

(72) Inventor: Brian J. Rampolla, Pittsburgh, PA (US)

(21) Appl. No.: 16/687,204

(22) Filed: Nov. 18, 2019

(51) Int. Cl. A01G 22/00; A01B 79/02; B09B 3/00

(52) U.S. Cl. CPC A01G 22/00; B09B 3/0025; A01B 79/02

(57) ABSTRACT

A method for providing long term carbon sequestration and reducing an individual's personal carbon footprint comprises: growing, harvesting, drying and grinding a plurality of weeds, then pressing the ground weeds into hollow block shells for manufacturing blocks therefrom. The hollow block shells could be made a recycled plastic, a plant based plastic, bamboo, a reclaimed wood fiber, ground up nut shells and/or a fungus material. The method, and the blocks manufactured thereby could conceivably impact total atmospheric carbon dioxide levels as a CO₂ Net Negative Emissions (NNE) technology.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable.

### STATEMENT REGARDING PRIOR DISCLOSURES BY THE INVENTOR OR A JOINT INVENTOR

Not Applicable.

### BACKGROUND OF THE INVENTION

### (1) Field of the Invention

This invention relates to the long term sequestration of carbon (C) removed from the atmosphere via plant (weed) photosynthesis of carbon dioxide (CO₂). Sequestration as applicable here results from the carbon containing bio-mass being ground and pressed into rigid shells so the bio-mass is protected from the normal decay process that would return most of the carbon to the atmosphere as part of the overall carbon cycle. Long term means at least 50 years. The blocks are engineered to have structural strength, including the use of internal reinforcement(s) for added strength so as to have numerous functional applications aside from sequestration alone.

### (2) Description of Related Art Including Information Disclosed Under 37 CFR 1.97 and 1.98

This invention falls under the general category of CO₂Net Negative Emissions (NNE) technologies, which the 2018 Intergovernmental Panel On Climate Change (IPCC) Report IPCC SR1.5 determined were necessary to supplement CO₂ emission reductions for achieving 1.5° C. maximum temperature increase. Reference [1] discusses the six primary NNE technologies: (i) Bio-Energy with Carbon Capture and Storage (BECCS), (ii) Forestation, (iii) Direct Air Capture (DAC), (iv) Biochar, (v) Enhanced Rock Weathering and (vi) Ocean Fertilization. They are summarized below with two additional technologies: (vii) Biomass Burial and (viii) Mass Timber.
Reference [1]: Rosen, J. “The Carbon Harvest”, Science, 2/16/18, Vol. 359, Issue 6377, pp. 733-737.

### i. Bio-Energy with Carbon Capture and Storage (BECCS)

Removal: photosynthesis conversion of CO₂ to carbon in biomass—combusted for energy
Capture: absorption filters subsequently heated to release concentrated CO₂
Storage: pumped into geologic formations

Issues
requires combustion
filter development required for high efficiency use—energy required to release captured CO₂
pumping CO₂ requires energy—risk that CO₂ will leak back to atmosphere
complex, expensive equipment required—metallic components possibly subject to corrosion
potential geologic formation instability leading to possible CO₂ release
not ready for large scale deployment
no functional use for stored carbon

### ii. Forestation

Removal/Capture/Storage: photosynthesis conversion of CO₂ to carbon in trees and roots

Issues
requires large amounts of land
a large tree may only sequester about 2,000 pounds of CO₂ over a 40 year lifespan (approximately 540 pounds C or about 14 pounds per year)

### iii. Direct Air Capture and Storage (DACS)

Removal/capture: filters treated with chemicals reactive with CO₂ that are later heated or processed by other methods to release CO₂ gas
Storage: pumped into geologic formations

Issues
does not require combustion
filter development required for high efficiency use—energy required to release captured CO₂
pumping CO₂ requires energy—risk that CO₂ will leak back to atmosphere
complex, expensive equipment required—metallic components possibly subject to corrosion
potential geologic formation instability leading to possible CO₂ release
not ready for large scale deployment
no functional use for stored carbon

### iv. Biochar

Removal: photosynthesis conversion of CO₂ to carbon in biomass
Capture: biomass combustion via high temperature, low oxygen pyrolysis, which retains carbon in the resulting charcoal
Storage: charcoal burial (serves as a high quality soil enhancer)

Issues
requires combustion
requires large scale, complex pyrolysis equipment
not ready for large scale deployment

### v. Enhanced Rock Weathering

Removal/capture/storage: pumping air into rock formations made of minerals that react with CO₂ to form solid carbonate rock

Issues
does not require combustion
large air pumps required—energy required to operate
not ready for large scale deployment

### vi. Ocean Fertilization

Removal/capture: purposeful introduction of nutrients to upper ocean enhances growth of phytoplankton, which absorb atmospheric CO₂ through skeletal formation
Storage: skeletal carbon carried to seafloor when plankton die

Issues
does not require combustion
no complex equipment required
significant concern for unanticipated consequences from excessive nutrients

### vii. Biomass Burial

Removal/capture: photosynthesis conversion of CO₂ to carbon in biomass
Storage: biomass is buried—removes carbon from carbon cycle

Issues
does not require combustion
normal biomass such as forests, corn, etc. requires high land use and expensive, energy intensive harvesting methods
large scale equipment required for burial
possible formation of methane in buried (anaerobic) conditions

### viii. Mass Timber

Removal/capture: photosynthesis conversion of CO₂ to carbon in trees
Storage: trees processed and formed into large-scale engineered wood products such as beams, studs, etc. used in large structures—carbon in the wood is sequestered for structures life

Issues
does not require combustion
forests require high land use and expensive, energy intensive harvesting methods
large scale equipment required to form timber structures—equipment uses energy

### BRIEF SUMMARY OF THE INVENTION

A method for providing long term carbon sequestration and reducing an individual's personal carbon footprint comprises: growing, harvesting, drying and grinding a plurality of weeds, then pressing the ground weeds into hollow block shells for manufacturing blocks therefrom. The hollow block shells could be made a recycled plastic, a plant based plastic, bamboo, a reclaimed wood fiber, ground up nut shells and/or a fungus material. The method, and the blocks manufactured thereby could conceivably impact total atmospheric carbon dioxide levels as a CO₂ Net Negative Emissions (NNE) technology.

### BRIEF DESCRIPTION OF THE SEVERAL VIEWS OF THE DRAWING(S)

Further features, objectives and advantages of this invention will be made clearer with the following description of preferred embodiments made with reference to the accompanying drawings in which:

FIG. 1 is a perspective view showing one embodiment of carbon block for manufacture according to this invention and its preferred dimensions for the same; and

FIG. 2 is a side-by-side view showing two blocks per this invention, the left side showing a doubly reinforced version and the right side a non-internally reinforced version.

### DETAILED DESCRIPTION OF THE INVENTION

In comparison to other CO₂ Net Negative Emissions technologies Key details of the subject invention, i.e., carbon blocks, compared to the above technologies are as follows:

### Carbon Blocks of this Invention

Removal: photosynthesis conversion of CO₂ to carbon in fast growing weeds
Capture: manual harvest, grinding, drying, pressing into blocks (minimal new carbon dioxide generation)
Storage: blocks are encased and sealed to completely sequester the carbon in the weeds

Issues
does not require combustion
weeds can be grown anywhere in marginal soil with natural rainfall and no fertilizer—can also be grown with other techniques such as vertical farms, greenhouses, hydroponic, etc.
weeds can be repeatedly grown in the same location, thus generating a large amount of sequestered carbon per acre per year.
weeds can be genetically modified to enhance photosynthesis efficiency thereby increasing carbon capture
all processing is manual providing exercise and minimal new emissions
no environmental risks associated with other techniques
blocks can be used in many applications.

It must be emphasized that these blocks are considered a Net Negative Emission (NNE) technology because they remove CO₂ without significant new emissions being that the energy required for block production is from essentially zero-emission human power. Further, the technology is decidedly “low tech” using readily available equipment resulting in low cost and immediate deployment.

Another key and unique advantage of the carbon blocks is that they provide the carbon capture benefits on both individual and global levels, as follows:

### Reduction of Individual Carbon Footprint

Because each block contains a fixed weight of carbon, each block made by each individual will offset their carbon footprint by that amount. At present, there is no other NNE technology producing such an offset allowing an individual to control their carbon footprint regardless of whether governments or industry do anything. Further, for someone deliberately leading a low carbon lifestyle, it may be possible for them to grind enough weeds for enough blocks so they live a carbon negative lifestyle, that is, they take out more atmospheric carbon in the form of the blocks than they put in as part of their carbon footprint. Again, no other NNE technology allows this situation.

### Large Scale Reduction of Atmospheric CO₂ Via Collective Action

Hundreds of millions of individuals each living a carbon negative lifestyle by making these blocks could conceivably reduce atmospheric CO₂ just enough to start ‘bending’ the emissions curve downward, thus providing more time for large scale low carbon power generation and transportation technology to be implemented. It is fully recognized that growing sufficient weeds to produce such benefit would be a challenge. However, this challenge is lessened by the fact that weeds of many varieties can be grown in just about any environment using advanced agricultural methods. The general term ‘weeds’ includes seaweed and similar saltwater tolerant vegetation for coastal areas.

### Comparison to Related Patents

As disclosed in U.S. Pat. Nos. 9,410,116 and 10,154,627, the described methods cover growing fungus and molding under pressure to specific shapes for structural applications, including integration of structural support members. In contrast to the subject carbon blocks of this invention, the process of growing fungus will not remove atmospheric carbon dioxide. Thus the final molded fungus shapes do not provide carbon sequestration, even though these shapes may be used for making the block shells described herein.

### Manufacturing Process

The five main steps are grow, harvest, dry, grind, and form, as detailed below:

1. Grow

Grow weeds at multiple locations around the world to capture CO₂ in the form of carbon in the plant structural proteins (primarily cellulose, lignin, hemicelluloses, pectin). Very roughly, raw vegetation is 50% water, and after drying the remaining plant material is about 50% C. So, ten (10) pounds of raw vegetation after drying will weigh five (5) pounds of which 2.5 pounds will be C. The focus is on weeds since they can be grown in marginal soil, so as to have no negative impact on food crops. And with no required irrigation, fertilizer, or pesticides, weeds should have no negative environmental impacts.

The weeds can also be grown in ‘vertical farms’ to maximize production in minimal space, in greenhouses for year round production, and using hydroponic techniques. Because there are so many weed species capable of growing in many environments, the optimum weed for each location can be selected. Saltwater tolerant weeds and seaweed can be grown in coastal areas. Further, there is significant research on what's called engineering photosynthesis with focus on genetic modifications to improve photosynthesis efficiency and carbon sequestration, which will result in biomass containing a higher percentage of carbon.

2. Harvest

Harvest weeds for drying using manual methods. Simplest method will be use of sickles.

3. Dry

Dry weeds using solar dryers. Such dryers are simple and readily available.

4. Grind

Grind weeds to allow consolidation into blocks. Grinding to be done by manual methods, such as a simple grinding mechanism attached to an exercise bike to which a hopper is attached that feeds the dried weeds to the grinder. Other exercise equipment can be modified to include a grinding mechanism. Further, specialized equipment can be designed so the handicapped can participate as well.

5. Form

Form the final blocks as follows:
Mix the dried and ground weeds with a waterproof and fireproof plant-based binder, which collectively becomes the ‘fill’. The binder being organic provides additional carbon sequestration, and when cured provides internal structural support to the block and prevents decomposition and fire issues if the external shell is damaged. The binder will also have additives to prevent biological action that would produce methane under the block internal anaerobic conditions.
Press the fill into hollow shells with one integral end and one open end. Allow the binder to cure, and insert an end piece at the open end attached with an adhesive/sealant. The complete shells provide a hard, external structure and are made from non-petroleum derived materials specifically intended to have as low a carbon foot print as possible, including:
   recycled or ocean plastic
   plant (including seaweed and kelp) based plastic
   solid natural material such as bamboo (properly treated to prevent cracking and deterioration)
   reclaimed wood fiber with a plant based binder, such as Fibrex
   composite materials made from ground up nut shells (almond, walnut, pistachio, etc.,), seashells, animal bones from food processing, and other appropriate waste material with a plant based binder
   fungus materials as described in the referenced patents
An option is installation of an internal skeleton to provide additional strength.
An option is to replace the weed fill with difficult to dispose of materials, such as landfill garbage or coal ash, as a means of long term solid waste disposal.

The above emphasis on manual labor is important because such labor produces minimal CO₂ emissions, thus maximizing the block carbon removal benefit. Further, all the labor, especially for grinding, provides a significant means of healthy exercise. All the process steps can be mechanized as needed to scale up for large-scale application, recognizing that use of mechanized equipment will reduce the net CO₂ removal.

### Carbon Block Configurations and Applications

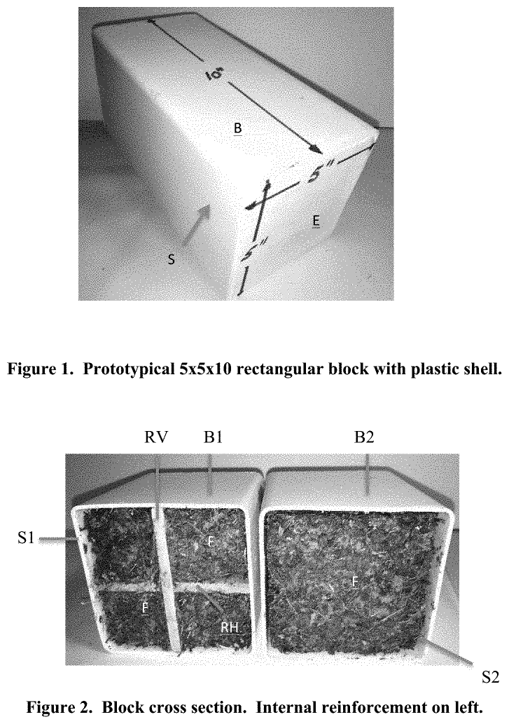

The prototypic block, item B in FIG. 1, is 5″×5″×10″ long, consisting of a thin walled shell S, end pieces E, and the fill F (better seen with the two views of rectangular blocks B1, B2 in FIG. 2). For the latter two versions, the first (or left) with internal reinforcement structural supports, one vertical RV and the other horizontally extending RH. Such blocks in this scale shall weigh about 5 pounds of which 1¾ pounds, or 35%, is carbon, with overall density of 0.02 pound per cubic inch. By contrast, a standard brick with density of 0.07 pound per cubic inch weighs about 17 pounds and contains essentially zero carbon. In practice, the blocks can be just about any size and even different shapes. The carbon percentage in a given block can also be increased using weed species that naturally capture more carbon.

In addition to sequestering carbon, the blocks have functional applications because of their structural strength. The basic block with no internal reinforcement will have measurable compressive strength from the compressed weed fill and the shell. The internal reinforcement will provide additional compressive strength. Bending and torque resistance can be generated by specifically engineering the shell thickness and internal reinforcement configuration, including 3D printing the internal reinforcement to provide customized configurations matched to the required properties. The resulting block applications are numerous, including, but not restricted to:
garden walls and other such simple, relatively lightly loaded structures made from individual unreinforced blocks
reinforced blocks with high strength to weight ratio for more highly loaded structures to replace the much heavier brick or concrete blocks
blocks wired or otherwise tied together providing fill material for larger landscaping applications to reduce required amount of dirt or sand—this application can include use of the blocks to build-up coastal areas to combat sea level rise
reinforced blocks combined as structural columns for insertion in old mines for ceiling support to prevent mine subsidence
engineered blocks combined as structural, lightweight beams

Having described several preferred embodiments, it is to be understood that this invention may be otherwise embodied in the following method and product claims.

### SEQUENCE LISTING

Not applicable.

1. A method for manufacturing blocks of dried weeds for long term carbon sequestration and reducing an individual's personal carbon footprint, said method comprising the steps of:
(a) growing a plurality of weeds;
(b) harvesting the plurality of grown weeds;
(c) drying the plurality of harvested weeds;
(d) grinding the plurality of dried weeds; and
(e) pressing the plurality of ground weeds into one or more hollow block shells for manufacturing blocks therefrom.

2. The method of claim 1 wherein step (a) includes growing the plurality of weeds in marginal soil to prevent loss of land for food crops.

3. The method of claim 1 wherein step (a) includes growing the plurality of weeds by one or more enhanced agricultural techniques selected from the group consisting of: vertical farms, greenhouses and hydroponics.

4. The method of claim 1 wherein step (a) includes genetically modifying the plurality of weeds to improve photosynthesis efficiency.

5. The method of claim 1 wherein the plurality of weeds in step (a) includes genetically modified seaweed.

6. The method of claim 1 wherein step (c) includes using a plurality of solar driers.

7. The method of claim 1 wherein step (d) includes using one or more grinders attached to exercise equipment selected from the group consisting of an exercise bike, a treadmill, a step machine and an elliptical machine.

8. The method of claim 1 wherein step (d) includes using one or more grinders specially designed for use by handicapped individuals.

9. The method of claim 1, which further includes after step (d), mixing the plurality of ground weeds with a waterproof and fireproof organic binder.

10. The method of claim 1, which further includes after step (d), mixing the plurality of ground weeds with one or more difficult to dispose of waste materials including compacted landfill garbage and coal ash.

11. The method of claim 1 wherein one or more of the hollow block shells in step (e) includes one or more internal structural reinforcements.

12. The method of claim 1 wherein one or more of the hollow block shells in step (e) is made from a material selected from the group consisting of: a recycled plastic, a plant based plastic, bamboo, a reclaimed wood fiber, ground up nut shells, a fungus material and combinations thereof.

13. The method of claim 1, which further includes after step (e), applying a sealant to an exterior surface of one or more of the hollow block shells.

14. The method of claim 1, which further includes after step (e), joining together one or more of the hollow block shells with an epoxy, plurality of fasteners, one or more drilled in rods or combinations thereof to make large-scale structures using such manufacturing blocks.

15. A manufactured block for long term carbon sequestration and reducing an individual's personal carbon footprint, said manufactured block comprising:
(a) a hollow block shell into which is pressed;
(b) a plurality of weeds that are grown, harvested, dried and ground for use as a filler for the hollow block shell.

16. The manufactured block of claim 15 wherein the hollow block shell is made from a material selected from the group consisting of: a recycled plastic, a plant based plastic, bamboo, a reclaimed wood fiber, ground up nut shells, a fungus material and combinations thereof.

17. The manufactured block of claim 15 wherein the hollow block shell includes one or more internal structural reinforcements.

18. The manufactured block of claim 15 wherein the plurality of weeds includes at least some genetically modified seaweed.

19. The manufactured block of claim 15 wherein the plurality of weeds further includes a waterproof and fireproof organic binder.

20. The manufactured block of claim 15 wherein the plurality of weeds further includes one or more difficult to dispose of waste materials including compacted landfill garbage and coal ash.
